(19) United States
(12) Patent Application Publication
(10) Pub. No.: US 2010/0028824 A1
(43) Pub. Date: Feb. 4, 2010

(54) METHODS AND APPARATUS FOR DETERMINING AND OPTIMIZING EFFECTIVENESS OF EXO-SHELL DENTAL ALIGNMENT APPLIANCE

(76) Inventors: Robert Steven Sears, Round Hill, VA (US); William Stuart Trimmer, Hillsborough, NJ (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/185,466

(22) Filed: Aug. 4, 2008

(51) Int. Cl. A61C 7/00; A61C 7/08

(52) U.S. Cl. 433/24; 433/6

(57) ABSTRACT

A method and apparatus for aligning the dento-facial region of a human. In one embodiment the method comprises providing an alignment appliance containing one or more optical elements; causing or instructing a human to cause the optical elements of the alignment device to come into contact with the dento-facial region, measuring or instructing the human to measure data regarding one or more characteristics of optical elements of the alignment appliance; modifying or causing to modify the alignment appliance to come into contact with the dento-facial region at different areas or by applying different forces to align the one or more teeth and repeating or causing to repeat one or more of steps of the method to align the dento-facial region of a human.

### BACKGROUND

1. Field

The present disclosure relates generally to methods and apparatus for positioning and aligning the dento-facial region, which includes teeth, jaws and the mandibular joint and optimizing the effectiveness of dental alignment appliances. More specifically, the present disclosure relates to methods and apparatus for using structured lighting techniques with and without an alignment appliance to position and align the dento-facial region.

2. General Background

A beautiful smile is a wonderful thing. It improves one's appearance and self-confidence. In addition, properly aligned teeth also improve one's dental hygiene and general health. Orthodontics is the dental specialty that involves diagnosing and converting malocclusions. By aligning the teeth and jaws, orthodontic clinicians can provide beautiful and healthy smiles for their patients. Knowledge about the forces applied to the teeth and the motions of the teeth are most helpful in enabling orthodontic treatment to become faster, more efficient, and better tolerated by the patients.

Methods of aligning teeth are well known in the art. One method of aligning the dento-facial region involves using an alignment appliance, such as a shell or other device that at least partially surrounds or is adjacent to some portion of the dento-facial region (e.g., teeth) applying forces to those regions causing them to move into alignment relative to each other over time. Among other things, the improved alignment improves the patient's appearance. Sometimes, the alignment appliance is a plastic structure that fits over and around the teeth and applies relatively gentle forces on the teeth from various directions. Properly designed, different shells can be used, in succession, to vary the forces applied to the dento-facial region, result in gradual alignment of the desired area.

Often times one or more shells, which are often referred to as exo-shells or aligner shells, are used to align a patient's teeth. Unfortunately, these shells, which are well known in the art, align portions of the dento-facial region using rather crude and haphazard techniques, which prevent effective alignment and positioning of teeth. For example, shells are typically created to have shape, rigidity and construction that applies forces and torques to the dento-facial region, which, over time, act to align portions of the dento-facial region relative to each other. Unfortunately, this technique does not allow those forces and torques to be applied to precise areas of the dento-facial region for the appropriate amount of time to properly align the teeth. Often times the forces applied are not the ideal amount or in the ideal location, resulting in misalignment or little to no alignment.

Additionally, due to misalignment and improper positioning of the shell relative to the dento-facial region, often times the forces and/or torques that are applied are not the appropriate amount or in the correct direction/orientation to cause efficient and effective alignment. Accordingly, the forces and/or torques applied by the exo-shell are directed to the wrong areas or location. Each of these factors prevent the efficient and effective alignment of the dento-facial region.

In order to maximize the effectiveness of any alignment appliance, a number of attributes regarding the alignment appliance and its effect on aligning teeth should be known and used in providing a method of aligning the dento-facial region. For example, knowing the position of the teeth in the appliance and whether one or more tooth is misaligned or misregistered relative to another tooth or the shell is helpful to allow the effective alignment of the patient's teeth. Additionally, accurate information regarding the motion of the teeth relative to the appliance during the course of the orthodontic treatment is also helpful to provide effective and efficient alignment. Furthermore, accurate information regarding the forces and/or torques that are applied or were applied to each individual tooth allows for optimal methods and apparatus for aligning teeth. Additionally, it reduces costs, time and effort associated with misalignment and the additional alignment appliances that are used/created with prior art methods of teeth alignment. Ideally, this and other related information can be used with present methods, systems and apparatus for aligning portions of the dento-facial region and orthodontic practices to provide a more effective and cost efficient method of aligning teeth which provides numerous additional benefits and advantages. The present invention provides these and other related advantages.

### SUMMARY

In at least one embodiment, a method of aligning the dento-facial region of a human is provided. The method includes but is not limited to providing an alignment appliance for aligning the dento-facial region of a human wherein the alignment appliance contains one or more retro-reflectors, causing or instructing the human to cause at least the one or more retro-reflectors of the alignment device to come into contact with the dento-facial region or transmit forces to the dento-facial region; measuring or instructing the human to measure data regarding one or more characteristics of the one or more retro-reflectors of the alignment appliance; obtaining data from the one or more characteristics of the one or more retro-reflectors of the alignment appliance; modifying or causing to modify the alignment appliance containing one or more retro-reflectors to come into contact with the dento-facial region at different areas or by applying different forces to align the one or more teeth; and repeating or causing to repeat one or more of steps (d) and (e) to align the dento-facial region of a human.

In an aspect of at least one embodiment of the present disclosure, using the data from one or more characteristics of the one or more retro-reflectors to modify or cause to modify the alignment appliance results in the more proper alignment of the alignment appliance and the dento-facial region and more appropriate forces being applied from the alignment appliances to the dento-facial region.

In another aspect of at least one embodiment of the present disclosure, the alignment appliance is an exo-shell and the dento-facial region is one or more teeth.

In yet another aspect of at least one embodiment of the present disclosure, the exo-shell also includes one or more optical elements.

In yet another aspect of at least one embodiment of the present disclosure, the one or more characteristics of the one or more retro-reflectors includes one or more of the distance between the exo-shell and the one or more teeth, the distance between the one or more retro-reflectors and the one or more teeth, the motion between different areas of the one or more teeth; the force or forces applied by the exo-shell to the one or more teeth, the force or forces applied by any area of the one or more teeth to another area of the one or more teeth, the distance between the exo-shell and one or more areas of the one or more teeth, the amount of light from one or more retro-reflectors, the amount of light reflected from the one or more retro-reflectors, the distortion of the one or more retro-reflectors, the decrease or increase in reflected light from the one or more retro-reflectors and the angle or orientation of one or more areas of the one or more teeth relative to the exo-shell or one or more retro-reflectors.

In yet another aspect of at least one embodiment of the present disclosure, the retro-reflector is incorporated into or adjacent to the exo-shell.

In yet another aspect of at least one embodiment of the present disclosure, causing or instructing the human to cause at least the one or more retro-reflectors of the exo-shell to come into contact with the one or more teeth causes physical distortion of the one or more retro-reflectors thereby reducing or decreasing the amount of light that is reflected from the one or more retro-reflectors.

In yet another aspect of at least one embodiment of the present disclosure, causing or instructing the human to cause at least the one or more retro-reflectors to come into contact with the one or more teeth causes the one or more retro-reflectors to be distorted thereby reducing or decreasing the amount of light that is internally reflected from the retro-reflectors.

In yet another aspect of at least one embodiment of the present disclosure, the one or more retro-reflectors have different heights and wherein causing or instructing the human to cause at least the one or more retro-reflectors of the exo-shell to come into contact with the one or more teeth causes a different physical distortion and reflection of light for the one or more retro-reflectors having different heights.

In yet another aspect of at least one embodiment of the present disclosure, the one or more retro-reflectors are at least partially enclosed or encased using a protective covering that prevents it from damage while in the human's mouth.

In yet another aspect of at least one embodiment of the present disclosure, at least one method disclosed further includes modifying or causing to modify one or more of the location, thickness, width, depth or height of the one or more retro-reflectors of the exo-shell to align the one or more teeth.

In yet another embodiment of the present disclosure, a method of aligning one or more teeth of a human is provided. The method includes providing a shell for aligning one or more teeth of a human wherein the shell contains one or more spacers or retro-reflectors, causing or instructing the human to cause at least the one or more spacers or retro-reflectors of the shell to come into contact with the one or more teeth, measuring or instructing the human to measure one or more characteristics of the one or more spacers or retro-reflectors of the shell, obtaining or causing to obtain data from the one or more characteristics of the one or more spacers or retro-reflectors of the shell, modifying or causing to modify one or more of the position, orientation or dimensions of the one or more spacers or retro-reflectors of the shell and repeating or causing to repeat one or more of steps (d) and (e) to align the one or more teeth of a human.

In yet another aspect of at least one embodiment of the present disclosure, modifying or causing to modify one or more of the position, orientation or dimension of the spacers or retro-reflectors of the shell to align one or more teeth causes the one or more spacers or retro-reflectors of the shell to come into contact with the different areas of the one or more teeth at different times to align the one or more teeth.

In yet another aspect of at least one embodiment of the present disclosure, the spacers or retro-reflectors of the shell contain a clear aperture which allows light to pass through them.

In yet another aspect of at least one embodiment of the present disclosure, the optical elements include any combination of one or more colored filters, fractional wave plates, polarizers or Fabre pérots interferometer.

In yet another aspect of at least one embodiment of the present disclosure, the spacers or retro-reflectors contain opaque and clear regions such that any light falling on an underlying surface of the spacers or retro-reflectors changes based on the separation between the surface of the spacers or retro-reflectors and the surface of one or more teeth. The change in light indicates the amount of separation between the surface of the one or more spacers or retro-reflectors or shell and the surface of the one or more teeth.

In yet another aspect of at least one embodiment of the present disclosure, measuring or instructing the human to measure one or more characteristics of the one or more spacers or retro-reflectors of the shell means measuring the light reflected back through the clear apertures to determine the separation between the one or more spacers or retro-reflectors of the shell or the shell and the one or more teeth.

In yet another aspect of at least one embodiment of the present disclosure, measuring or instructing the human to measure one or more characteristics of the one or more spacers or retro-reflectors of the shell means measuring the moire patterns formed between the clear apertures and the underlying shadows of the one or more spacers or retro-reflectors.

In yet another aspect of at least one embodiment of the present disclosure, measuring or instructing the human to measure one or more characteristics of the one or more spacers or retro-reflectors of the shell means measuring the total internal reflection of light and illumination of the underlying surface of the one or more spacers or retro-reflectors to determine the separation between the spacers or retro-reflectors of the shell or the shell and the one or more teeth.

In yet another embodiment of the present disclosure, an apparatus for aligning one or more teeth of a human being is provided. The apparatus includes a semi-resilient to resilient shell containing one or more spacers or retro-reflectors of which at least one is capable of coming into contact with one or more teeth of a human being wherein the shell is constructed in such a manner that the one or more spacers or retro-reflectors can be moved or removed to allow the shell and the one or more spacers or retro-reflectors to come into contact with different areas of the one or more teeth.

### DETAILED DESCRIPTION

It is important to know how an alignment appliance is performing to align the patient's teeth. Determining whether the correct forces are being applied to the teeth at the correct positions and in the best way possible is essential to the performance of the alignment appliance. Ideally, the patient at home could examine the appliance in his or her mouth and ascertain if the treatment is proceeding properly. Alternatively, the patient could also transmit the information to the doctor's office or to a third party for review and analysis. Another alternative would be for a doctor or other health professional to review and analyze the information from the alignment appliance in his or her office and make changes as needed based on the information he or she receives. A system that easily indicates the proper function of the alignment appliance would be very useful in a doctor or other health professional's office.

The ability to quickly and easily diagnose the operation of the appliance greatly enhances the alignment treatment and experience. Several things that are important to determine in order to provide proper and efficient alignment of the dento-facial region include but are not limited to whether the correct amount of force is being applied to the correct areas of the dento-facial region with the correct orientation, whether a tooth has moved from its proper position and is receiving proper torques and forces, whether the treatment plan and/or appliance being used needs to be changed and the proper dimensions, rigidity and contact points of the new alignment appliances, and when is the ideal time to use the next appliance in the series, if any. It should be appreciated that a treatment plan can be any plan or method used to provide proper alignment of the dento-facial region or the patients particular requests.

The present disclosure provides several novel methods and apparatus for measuring the effectiveness of an alignment appliance, including but not limited to using optical devices or elements and other devices (e.g., retro-reflectors, cat's eyes, corner cubes) which reflect light, fluorescence illumination, and shadows, sometimes thought one or more apertures, which provides useful data regarding the distance between the alignment appliance or optical element and the teeth of the patient and the forces and torques applied by the alignment appliance or optical element on the teeth of the patient, allowing for the optimization of the alignment appliance's ability to align teeth quickly and effectively without the need to create numerous additional appliances.

The present invention provides numerous advantages, including but not limited to reducing manufacturing costs associated with the alignment appliances. In a typical manufacturing process a mold is made using stereolithography, and a single alignment appliance (e.g., exo-shell) is formed over this mold. Using the methods and techniques well known in the art, multiple shells can be made on this same mold, and the devices and methods described herein can be used, along with variable thickness spacers, retro-reflectors, cat's eyes and/or corner cubes, to allow the same shell or a replication of the same shell to be used in several different stages of aligning the teeth. It should be appreciated that such techniques and devices provide the additional advantage of significantly reducing manufacturing and overall costs associated with aligning teeth but also provide, among other things, the additional advantage of improving the alignment appliances' ability to quickly and efficiently align teeth, in part by avoiding misalignment and the application of less than ideal forces and torques to the teeth, all of which occur with traditional alignment methods and apparatus.

As discussed herein, the methods disclosed herein include alignment appliances which include one or more optical elements that come into contact with one or more teeth of the individual desiring tooth alignment and, as discussed in at least one embodiment, by measuring the change in the optical properties of the optical elements and modifying the alignment appliances and optical elements based on the changes in the optical properties of the optical elements, a better more effective method of aligning teeth is provided. Below is a brief discussion of some of the optical elements that can be used as part of the present invention and how they provide the benefits and advantages discussed herein.

Retro-Reflectors

In at least one embodiment, one or more retro-reflectors are incorporated into or attached to an alignment appliance such that when a force is applied to the retro-reflectors, typically from the teeth of the person wearing the alignment apparatus, the optical characteristics of the retro-reflectors mechanically change in such a way as to change their optical characteristics. It should be appreciated that the term retro-reflector can include all supporting structures, encapsulating materials and spacers. Two types of well known retro-reflectors are corner cubes and cat's eyes.

An easy way to construct a corner cube is to mirror the surfaces of the corner of a room. At the corner the three walls meet each other at right angles; that is, the three surfaces are mutually perpendicular. The optic axis of this optical system is a line that runs from the apex out, such that the angle it makes with all three surfaces is the same.

Any ray traveling in the direction along the optic axis or at a small angle to the optic axis will strike all three surfaces of the corner cube in such a manner that the ray reflects back out at the same angle that it entered the corner cube. Hence, if one shines a flashlight at the corner cube, the rays will reflect back towards the flashlight. An example of this retro reflection is the taillights of cars which have small corner cubes built into the back side of the outer plastic layer. If one's headlights strike the corner cube on the car taillights, the light reflects generally in the direction of your car and the driver sees a bright taillight.

The corner cube is generally made in one of two ways. It can consist of mirrored orthogonal surfaces as in the above paragraph or it could be a solid surface with three mutually perpendicular surfaces. In the second instance the light travels through the object, strikes the three mutually orthogonal surfaces and is reflected by total internal reflection rather than mirror surfaces. The construction, use and employment of corner cubes is familiar to one of ordinary skill in the art and therefore is not disclosed in detail herein.

A second convenient way to make a corner cube is to place a mirror at the focal plane of a lens (that is a reflecting surface that intersects the focal point and is perpendicular to the optic axis). Here again, light passing through the lens strikes the mirror and passes back out again through the lens at the same angle that it entered. As in the case of the corner cube, the light reflected out of the cat's eye is, in general, displaced some distance from the entering beam. It is believed that a cat's eye was so named because when the headlights of a car strike a cat's eye, the retro-reflector effect reflects a lot of light back to the driver's eyes and causes two globes that glow eerily in the night. The cat interestingly has a reflecting layer in its eyes at the focal plane where humans do not have a reflecting layer. In the rest of this discussion, we will in generally discuss corner-cubes, but it should be understood that cat's eye works equally well and can be substituted for a corner cube in most if not all embodiments disclosed herein.

In at least one embodiment of the present invention, an alignment appliance with at least one as corner cube is provided. The corner cube applies force to one or more teeth of the person. Through application of the force, the corner cube distorts into a shape that is no longer three mutually perpendicular planes. Because of this distortion, much less light will be reflected back to the light source. Instead the light will tend to scatter out into a broad range of angles. Accordingly, in at least one embodiment, a large amount of light will be reflected back to a light source and an adjacent or coincident observer will see a very bright reflection of the corner cube. In another aspect of at least one embodiment of the present invention, the contact between the teeth and the distortion of the corner cube does not create a bright reflection back to a light source, indicating that the cube was not as distorted as it could be and the resulting force applied to the teeth of the person by the corner cube is less than it would be had the cube been more distorted and created a relatively brighter reflection. It should be noted that, often times when the retro-reflector is distorted or otherwise compromised, less light is reflected back to the observer.

As described above, one can tell whether the tooth is receiving force from the region of the corner cube merely by looking at the reflection from the light source. Indeed, if the corner cubes are placed in the regions where the shell is designed to apply force on the tooth, there will be no bright reflection. However, if the shell is misaligned, there will be a bright reflection indicating that the system is not aligned properly.

In yet another embodiment, in part to indicate areas of improper registering and force application between the tooth and alignment appliance, a colored (e.g., red) filter can be placed in the corner cube. By doing so, regions of the alignment appliance that are properly aligned will have not a bright red reflection, whereas improperly aligned regions will have a bright red reflection. This simple and clear indication can be used by a health care profession or the patient to determine if this treatment to properly align teeth is progressing properly.

It should be appreciated that the reflection in the corner cube usually depends upon total internal reflection. Other substances, including those from and in the mouth, on or near the surface of the corner cube can inhibit the total internal reflection and lessen the amount of light returned to the light source, which can be factored into the methods disclosed herein.

In another aspect of at least on embodiment of the present invention, a covering or protective implementation protects the corner cube from substances in the mouth. One example is a corner cube that has been sealed to protect the surface of the corner cube. In another aspect of at least one embodiment, one side of the sealed corner cube attaches to the inside of the alignment appliances and the opposite side is positioned so that it can contact the tooth. When the tooth is adjacent to the alignment appliance and in a position to receive force from the alignment appliances, the alignment appliances pushes against the tooth applying a force and concurrently touching, pushing, and distorting the corner cube. The side pushing against the corner cube destroys the retro reflector effect of the corner cube in several ways. First, when the surface of the appliance touches the corner cube bases, it eliminates the total internal reflection and most of the light passes through rather than being reflected. Second, the force from the surface applied to the corner cube distorts the corner cube again decreasing the reflective power of the corner cube. Third, the increased pressure inside the cavity can distort the entire optical structure decreasing the retro reflection.

It should be appreciated that as part of at least one of the embodiment of the present invention, the sealed corner cube can also be conveniently used as a spacer inside the shell. The corner cube spacer extends some distance from the shell and defines the expected point where the corner cube spacer touches the tooth. By allowing the layer towards the tooth to be thicker, the shell is allowed to be further from the tooth and still apply force on the tooth. By using corner cube spacers of different thicknesses, the cost of manufacturing the alignment appliance can be decreased and the need for additional alignment appliances, in some cases, can be eliminated.

In yet another aspect of at least one embodiment, one alignment appliance can be made by putting different spacers in the appliance that have different thicknesses. The spacers having different thicknesses allow the tooth to be progressively moved over a substantial distance. In a typical manufacturing processing, a mold is made and only a single shell is fabricated. With the methods disclosed herein, one mold can be made and multiple identical appliances can be fabricated on the one mold.

By placing different-thickness corner cube spacers in these three different appliances, these appliances can move one or more teeth farther and faster than any one static appliance. For example, and not by way of limitation, the first alignment appliance might have a relatively thin corner cube which move the tooth the first increment. The second appliance might have a relatively thicker corner cube. The extra thickness of this corned cube will continue the alignment of the tooth without the need for a completely new alignment appliance. The third shell can have a relatively even thicker corner cube allowing even further motion and alignment of the tooth.

Because a substantial part of the cost of manufacturing the appliances is the cost of manufacturing the mold, reducing the number of molds needed saves substantial manufacturing costs.

In yet another embodiment, an alignment appliance is provided, containing an optical element which is in front of the corner cube such that the light passes through the optical element and goes towards the corner cube and returns from the optical element. In yet another aspect of the present invention, the optical element may be a red filter. If there are no forces being applied to the corner cube, then the corner cube will appear as a bright red spot when it is properly illuminated. However, if the corner cube is applying force to the tooth, the affect of the corner cube will be disrupted, and it will not appear as a bright red spot. In this example, as long as the corner cubes are touching the teeth in the appropriate place, there will be no bright red indicator. However, if one of the corner cubes is not applying the desired force, then it will appear as a bright red spot indicating a region that may not be performing as per the desired treatment plan. In yet other embodiment, other optical elements are used, including but not limited to fractional wave plates such as an eight wave plate, a polarizer, a ronchi ruling, a material that is sensitive to pressure, a diffraction grading, or a Fabre Pérot interferometer or other optical element that is well known in the art.

In yet another embodiment, an alignment appliance is provided containing at least one spacer containing at least four corner cubes. The first corner cube has no filter, the second corner cube has a color filer (e.g., green filter) that is different in color from the others, the third corner cube has another color filter that is not the same color as any of the others (e.g., a blue filter) and the fourth has yet another filter that is not the same color as any of the others (e.g., red filter). These four corner cubes are designed such that a light force extinguishes (the corner cube is distorted so it loses the retro reflection property) the red filter corner cube, a light but clinically acceptable force extinguishes the blue, a strong but clinically acceptable force extinguishes the green, and the white corner cube is never extinguished. In this embodiment, if the appliance is applying too much force, only the white corner cube is reflecting light. If the spacer is applying force in the correct range, the white and green corner cubes and perhaps the blue corner cubes are reflecting light. If too much force is being applied by the spacer, all of the corner cubes, including the red corner cube, reflect light.

A person wearing the alignment appliances can look anywhere, including their home, at this region of the appliance with a mirror and tell if the correct force is being applied. The ability to provide out of office inspections done by the person wearing the appliance provides many advantages, including but not limited to allowing the dentist to schedule office visits further apart, detecting early when the wrong force is applied, detecting if a tooth has slipped out of the proper position in the shell, and generally alerting the patient and dental staff if there is a problem with the alignment process.

Optical Illumination

A requirement for the cat's eye or corner cube to reflect light back to a driver is that the light source and driver be close to each other. This is because in a properly constructed retro reflector, the light is reflected in a small solid angle about the incident angle, with the intensity of reflected light decreasing as one gets farther from the incident direction. Hence, if one is very close to the light source, one sees a bright light, and the closer one gets to the light source the brighter the returned light. There are two ways in general to design the light source for this system. One is to place the source of the light very close to the observer or camera. For example, the light source might be directly adjacent to the lens of a video camera. The second method is to actually place the light inside the lens. This second light source obviously has to be shielded so that it does not directly put light back into the camera.

Another way of illuminating the corner cube such that a large amount of light comes back to the camera is to use a half silvered mirror or other partially reflecting device. The camera looks through the half silvered mirror towards the corner cube. In addition, some of the light from the light source is reflected towards the corner cube. The rest of the light travels straight on and misses the camera. The light returning from the corner cube again goes through the half silvered mirror with some of it continuing to the camera and some of it being reflected towards the light source. Here, optically the light source appears coincident with the camera. The half silvered mirror could also be a dielectric mirror that is partially reflecting and partially transmitting, or could be a pellicle, or a small reflecting region or any other optical device that partially transmits and partially reflects. This is a way of cleanly separating the camera and the light source without physically making them adjacent. Instead of a half silvered mirror, a polarizing beam splitter, a dielectric beam splitter, or similar device can be used to optically superimpose the camera and light source.

Optics and Cat's Eye

As discussed above, the cat's eye also has the property of reflecting light back in the incident direction. This cat's eye can be used instead of the corner cube in the manner described above. For example, in yet another embodiment, a sealed cavity containing the cat's eye, lens, and reflecting surface, is provided. Because it's sealed, it is protected from the external environment of the mouth. In this configuration it can be used as a spacer between the tooth and the alignment appliance and different thicknesses can be used to provide a range of motions for alignment. If, for example, the sealed cat's eye was connected to the alignment appliance and the optical element or appliance comes into contact with the tooth in such a manner that the optical element was distorted and the reflecting surface pushed away from the focal plane of the lens, then the retro reflector-effect of this system is spoiled. It should be appreciated that this embodiment can be used with the same lighting configurations described herein and with different filters and other optical elements that can be incorporated into the sealed cat's eye.

Determination of Proper Orthodontic Forces

Being able to measure forces on teeth needing alignment and adjusting those forces as necessary is necessary to provide the most efficient and effective way of aligning the dento-facial region. Because people have not been able to measure the forces applied to teeth during orthodontic treatment, little is known about the appropriate forces and how they can best be implemented.

Force sensors can be placed such that they can measure the forces being applied to teeth during orthodontic treatment. In particular, one or several teeth will be chosen and a skilled orthodontist will perform his normal orthodontic treatment. This will enable the force sensors to determine what range of forces a skilled orthodontist applies and what sort of tooth moves as a result. This work can then be extended to other teeth and other treatment plans. Once a baseline has been established, one can then vary the force within prescribed limits and measure the therapeutic effect of these forces. These second measurements will allow a better understanding of the appropriate forces and what motions they generate. This data then becomes a baseline for a third set of investigations where other factors such as race, ethnicity, age, size, and general bone structure are examined. Indeed, it is quite possible that different groups of people may require substantially different treatments. As these databases grow in subsequent years one expects to develop a finer and finer understanding of what are the right forces.

Power Law Measurements

The intensity of light from a point light source falls off with a power law of one over r squared. This power law is easily seen by considering a sphere of radius r. If a certain amount of power is admitted by the light source, this light will fall evenly upon a sphere centered on the light source. If a second sphere is twice the size, this same amount of power falls on the second sphere. But now the area of the second sphere is four times the size and the intensity of light on the sphere has dropped by a factor of 4. The size of the sphere depends upon its radius squared and hence, the intensity of light falling on a larger sphere drops off as the power law of one over r squared.

The dropping off of light intensity as one moves farther from the light source by some well-defined power law is quite useful in measuring the interaction between the shell and tooth. In the case of one over r squared power law dependence from a light source, if the light strikes a small object, the light reflected back towards the light source also drops off as one over r squared, and the total amount of light returning to the light drops off as one over r to the fourth power. This means there is a dramatic drop in the intensity of the light reflected back from a small object as the object recedes. For example, if an object moves ten times farther away the light intensity drops by a factor of 100 (as the distance r squared) and the light returned from the small object also decreases by a factor of 100 meaning the total intensity of the light reflected back drops off by a factor of 10,000, a substantial change in intensity.

The Pin Hole

In yet another embodiment, an alignment appliance is provided with at least one opaque object with a small pinhole in the center that allows light to pass through it. If an object such as a tooth or white piece of paper is up against this opaque object, the light going through the pinhole strikes the paper or tooth and reflects back out. However, if the paper or tooth is substantially farther away, the light drops off approximately as one over r squared going to the paper, and one over r squared coming back to the pin hole. (The exact power law is more complicated and is determined by the exact geometry and the characteristics of the reflecting object, but can be calculated or measured.) Hence, if a reflecting object is against the pinhole, there is a high intensity reflected, and if the object is away from the pinhole, there is little light reflected. This makes an excellent sensor. In yet another embodiment, the alignment appliance has an opaque object with a clear pinhole and the amount of light reflected back through the pinhole is characteristic of the separation between the tooth and opaque object.

Multiple Apertures

Instead of there being a single pinhole or clear aperture there can be a plethora of apertures. There are several different ways to design this type of system as discussed below.

In yet another embodiment of the present invention, an alignment appliance is provided, having at least one opaque object with a number of small apertures which allow light to pass through. The divergence of the light causes a smooth illumination or an illumination that varies by a small amount. If the camera looks from a different angle, it can detect whether there is a bright illumination from the underlying object being close to the open apertures or whether there is a fainter and more diffuse illumination when the underlying surface is at some distance to these apertures. The opposite situation works equally well, where there are a number of small opaque objects and the remaining area is clear. When the underlying object is against these opaque objects, the region between them appears bright and as the other underlying object moves away, the light first appears as an undulating intensity and then at further distances smooths out to a smoother illumination with some undulations In the case of the small opaque areas, it is easier to see the changing effect because of the large clear areas that a camera can look through. In both cases one can easily tell whether an object such as a tooth is close to or further from the apertures.

One can also design either the clear or opaque apertures discussed above such that they form moire patterns and these moire patterns can be used to determine things such as camera separation and camera angle of the underlying surface.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method of aligning the dento-facial region of a human comprising:
(a) providing an alignment appliance for aligning the dento-facial region of a human wherein the alignment appliance contains one or more retro-reflectors;
(b) causing or instructing the human to cause at least the one or more retro-reflectors of the alignment device to come into contact with the dento-facial region;
(c) measuring or instructing the human to measure data regarding one or more characteristics of the one or more retro-reflectors of the alignment appliance;
(d) obtaining data from the one or more characteristics of the one or more retro-reflectors of the alignment appliance;
(e) modifying or causing to modify the alignment appliance or treatment plan containing one or more retro-reflectors to come into contact with the dento-facial region at different areas or by applying different forces to align the one or more teeth; and
(f) repeating or causing to repeat one or more of steps (d) and (e) to align the dento-facial region of a human.

2. The method of claim 1, wherein using the data from one or more characteristics of the one or more retro-reflectors to modify or cause to modify the alignment appliance results in the more proper alignment of the alignment appliance and the dento-facial region and more appropriate forces being applied from the alignment appliances to the dento-facial region.

3. The method of claim 1, wherein the alignment appliance is an exo-shell and the dento-facial region is one or more teeth.

4. The method of claim 3, wherein the exo-shell also includes one or more optical elements.

5. The method of claim 3, wherein the one or more characteristics of the one or more retro-reflectors includes one or more of the distance between the exo-shell and the one or more teeth, the distance between the one or more retro-reflectors and the one or more teeth, the motion between different areas of the one or more teeth; the force or forces applied by the exo-shell to the one or more teeth, the force or forces applied by any area of the one or more teeth to another area of the one or more teeth, the distance between the exo-shell and one or more areas of the one or more teeth, the amount of light from one or more retro-reflectors, the amount of light reflected from the one or more retro-reflectors, the distortion of the one or more retro-reflectors, the decrease or increase in reflected light from the one or more retro-reflectors and the angle or orientation of one or more areas of the one or more teeth relative to the exo-shell or one or more retro-reflectors.

6. The method of claim 1, wherein the retro-reflector is incorporated into or adjacent to the exo-shell.

7. The method of claim 6, wherein causing or instructing the human to cause at least the one or more retro-reflectors of the exo-shell to come into contact with the one or more teeth causes physical distortion of the one or more retro-reflectors thereby reducing or decreasing the amount of light that is reflected from the one or more retro-reflectors.

8. The method of claim 3, wherein causing or instructing the human to cause at least the one or more retro-reflectors to come into contact with the one or more teeth causes the one or more retro-reflectors to be distorted thereby reducing or decreasing the amount of light that is internally reflected from the retro-reflectors.

9. The method of claim 3, wherein the one or more retro-reflectors have different heights and wherein causing or instructing the human to cause at least the one or more retro-reflectors of the exo-shell to come into contact with the one or more teeth causes a different physical distortion and reflection of light for the one or more retro-reflectors having different heights.

10. The method of claim 1, where the one or more retro-reflectors are at least partially enclosed or encased using a protective covering that prevents it from damage while in the human's mouth.

11. The method of claim 3, where the method further comprises:
modifying or causing to modify one or more of the location, thickness, width, depth or height of the one or more retro-reflectors of the exo-shell to align the one or more teeth.

12. A method of aligning one or more teeth of a human comprising:
(a) providing a shell for aligning one or more teeth of a human wherein the shell contains one or more spacers or retro-reflectors;
(b) causing or instructing the human to cause at least the one or more spacers or retro-reflectors of the shell to come into contact with the one or more teeth;
(c) measuring or instructing the human to measure one or more characteristics of the one or more one or more spacers or retro-reflectors of the shell;
(d) obtaining or causing to obtain data from the one or more characteristics of the one or more spacers or retro-reflectors of the shell;
(e) modifying or causing to modify one or more of the position, orientation or dimensions of the one or more spacers or retro-reflectors of the shell; and
(f) repeating or causing to repeat one or more of steps (d) and (e) to align the one or more teeth of a human.

13. The method of claim 12, wherein modifying or causing to modify one or more of the position, orientation or dimension of the spacers or retro-reflectors of the shell to align one or more teeth causes the one or more spacers or retro-reflectors of the shell to come into contact with the different areas of the one or more teeth at different times to align the one or more teeth.

14. The method of claim 12, wherein the spacers or retro-reflectors of the shell contain a clear aperture which allows light to pass through them.

15. The method of claim 4, wherein the optical elements include any combination of one or more colored filters, fractional wave plates, polarizers or Fabre Pérots interferometer.

16. The method of claim 13, wherein the spacers or retro-reflectors contain opaque and clear regions such that any light falling on an underlying surface of the spacers or retro-reflectors changes based to the separation between the surface of the spacers or retro-reflectors and the surface of one or more teeth in such a way as to indicate the amount separation between the surface of the one or more spacers or retro-reflectors or shell and the surface of the one or more teeth.

17. The method of claim 14, wherein measuring or instructing the human to measure one or more characteristics of the one or more one or more spacers or retro-reflectors of the shell means measuring the light reflected back through the clear apertures to determine the separation between the one or more spacers or retro-reflectors of the shell or the shell and the one or more teeth.

18. The method of claim 14 where wherein measuring or instructing the human to measure one or more characteristics of the one or more spacers or retro-reflectors of the shell means measuring the moire patterns formed between the clear apertures and the underlying shadows of the one or more spacers or retro-reflectors.

19. The method of claim 14 where wherein measuring or instructing the human to measure one or more characteristics of the one or more spacers or retro-reflectors of the shell means measuring the total internal reflection of light and illumination of the underlying surface of the one or more spacers or retro-reflectors to determine the separation between the spacers or retro-reflectors of the shell or the shell and the one or more teeth.

20. An apparatus for aligning one or more teeth of a human being, the apparatus comprising:
a semi-resilient to resilient shell containing one or more spacers or retro-reflectors which at least one or which is capable of coming into contact with one or more teeth of a human being;
wherein the shell is constructed in such a manner that the one or more spacers or retro-reflectors can be moved or removed to allow the shell and the one or more spacers or retro-reflectors to come into contact with different areas of the one or more teeth.
